(19) United States
(12) Patent Application Publication
(10) Pub. No.: US 2018/0119298 A1
(43) Pub. Date: May 3, 2018

(54) IODIDE REMOVAL FROM BRINE USING ION RETARDATION RESINS

(71) Applicant: Chemetics Inc., Vancouver (CA)

(72) Inventors: Felix Mok, Vancouver (CA); Ganapathy Ramasubbu, Delta (CA)

(21) Appl. No.: 15/557,421

(22) PCT Filed: Mar. 8, 2016
(86) PCT No.: PCT/US2016/021392

§ 371 Date: Sep. 11, 2017

Related U.S. Application Data
(60) Provisional application No. 62/131,530, filed on Mar. 11, 2015.

(51) Int. Cl. C25B 15/08; C02F 1/42; C02F 1/66; C25B 1/46; C01D 3/14

(52) U.S. Cl. CPC C25B 15/08; C02F 1/42; C02F 2101/12; C25B 1/46; C01D 3/145; C02F 1/66

(57) ABSTRACT

Methods are disclosed for removing alkali metal iodide from concentrated aqueous alkali metal chloride solutions using ion retardation resins. The methods are suitable for solutions comprising substantially more than 1 ppm iodide and greater than 100 g/l alkali metal chloride and can remove the iodide to levels below 1 ppm. To effect removal, the pH of the solution is adjusted to be less than about 10 and is then flowed through a separation bed comprising the resin in a series of loading and elution cycles. The method is particularly useful for removing iodide impurity from the concentrated feed brine used in chloralkali electrolysis.

### TECHNICAL FIELD

The present invention pertains to methods for the removal of iodide anions from concentrated alkali metal chloride solutions using ion retardation resins, and particularly from the concentrated sodium chloride solutions used in chloralkali electrolysis.

### BACKGROUND

Many sources of brine (i.e. a solution of an alkali metal chloride) contain less than 1 ppm iodide, but higher levels are found in brine associated with oil and gas fields and in salt deposited from sea water. Sea water contains about 35,000 ppm total salts and 0.05 ppm iodide which is equivalent to approximately 0.5 ppm iodide in concentrated brine solutions. The many types of brine solutions are commonly considered and used as raw material feedstocks in various chemical processing industries, such as the chloralkali industry.

Iodide, when present in the feed brine used in membrane chloralkali electrolysis, is generally in the form of sodium iodide and tends to be oxidized to periodate inside the ion-exchange membrane of the electrolyzer by the dissolved chlorine in the anolyte compartment as follows:

I-+Cl₂+4H₂O→IO₄⁻+8Cl⁻+8H⁺

The IO₄⁻ electromigrates through the membrane towards the high pH zone and becomes paraperiodate (IO₆⁻), which precipitates as Na₃H₂IO₆ in the highly selective carboxylic acid layer and causes an increase in cell voltage, thus directly resulting in a reduction in current efficiency. When cationic impurities such as Ca, Sr, and Ba are also present in the feed brine in ppm concentration, the effect of voltage increase is further exacerbated with precipitation of the more insoluble metal paraperiodates, Ba₃(H₂IO₆)₂, Sr₃(H₂IO₆)₂, Ca₃(H₂IO₆)₂ being promoted not only on the caroboxylic layer, but also on the conductive sulphonic layer. The reduction in current efficiency as reported by chloralkali operators could be as high as 5%, and the cost of membrane replacement due to irreversible damage of the ion-exchange membrane also contributes a significant portion of the overall operating costs.

Therefore, it is important to ensure that iodide impurities in the feed brine be maintained and controlled to a specified limit in order to avoid precipitation on membrane surfaces. Presently, the concentration limit as stipulated by membrane manufacturers is set at less than about 1 ppm iodide, with Ca, Sr and Ba in the ppb level.

At present, the only effective commercial strategy for controlling the iodide impurites in feed brine to the required level for membrane chloralkali electrolysis seems to employ brine purges, which is both costly and not environmentally friendly. Recently in EP0659686, an ion-exchange process was disclosed which used strong base anion exchange resins to separate out iodide impurities by oxidization to form negatively charged iodo-chloro complexes (ICl₃⁻) with strong affinity to anionic exchange chelation. However, this process suffers from overall complexity as well as several technical issues. For instance, the formation of the iodo-chloro complex only occurs within a narrow redox potential region in an oxidative environment and its stability is greatly influenced by the surrounding conditions. When exposed to the strong base anion exchange resins, the oxidizing properties of the solution matrix can promote chemical degradation of the ion-exchange resins, thus directly impacting on the overall performance. Further still, the process requires a chemical regeneration step using a reductant (e.g. a sodium sulphite solution) for regeneration of the anion exchange resins. The resulting waste regenerant solution then needs to be chemically treated for final disposal. A less complex and more reliable approach would thus be preferred.

Ion retardation resins, also known as amphoteric resins, contain both anionic and cationic adsorption sites which are so closely associated that they partially neutralize each other's electrical charges. Such resins are disclosed in detail for instance in U.S. Pat. No. 3,078,140. However, the sites still have sufficient attraction for mobile anions and cations that the resins can adsorb both cations and anions from a solution with which it comes in contact. The adsorbed ions can then be displaced from the ion retardation resins by the use of water as an eluant. A variety of such resins are commercially available, including Dowex Retardion 11A8 from Dow Chemical Company or the Diaion types from Mitsubishi Chemical Corporation. The former 11A8 resin, which is also known as a snake-in-a-cage type resin, contains both weak acid cation and strong base anion functionality within the same resin. Ions are separated from each other based on their affinity to the adsorption sites. The latter Mitsubishi Diaion types are classified as betaine type resins which involve a neutral chemical compound with a positively charged cationic functional group and with a negatively charged functional group. The two types of resins can fundamentally exhibit similar ion retarding action.

The use of ion retardation resins for the separation of sodium chloride, sodium chlorate and sodium sulphate in ionic solution has been successfully demonstrated and commercially applied in the chloralkali industry. Depending on the degree of affinity of the various ions to the ion retardation resins, elution of the adsorbed ions can be achieved by passing demineralised water to fractionate mixtures of highly ionized substances to enable recovery and reuse of the major chemical components. This simpler water “regeneration” is unlike that required for common ion-exchange resins, where the cations or anions are ionically exchanged and held strongly or captured at the exchange sites thus needing the use of regeneration chemicals that can displace the captured ions. Furthermore, the resulting regeneration effluent solutions in conventional “capture” ion exchange systems must also be treated before disposal. Since ion retardation requires only water for “regeneration”, it can be more profitably employed where ion exchange is not economically practical, especially in complex ionic solution matrices.

However, while ion retardation resins offer certain known benefits, it is also well known by those in the field that the behavior of such resins is only somewhat predictable with regards to dilute solutions or solutions of relatively simple composition. When several different anions and/or cations are involved, in highly concentrated solutions, substantial ion-ion interactions may occur thereby markedly complicating the situation. Thus, separation results obtained in complex (multi-species) concentrated solutions cannot readily be predicted and especially with regards to separations involving certain species at very small concentrations and other species at relatively very large concentrations.

There remains a need to develop and identify means for the simple and reliable removal of alkali metal iodide from aqueous alkali metal chloride solutions, particularly in industrial chloralkali electrolysis. The present invention addresses this need and provides other benefits as disclosed below.

### SUMMARY

The present invention provides methods for removing substantial amounts of alkali metal iodide from concentrated aqueous alkali metal chloride solutions via the use of appropriate ion retardation resins. The methods are suitable for solutions comprising substantially more than 1 ppm iodide and greater than 100 g/l alkali metal chloride and the iodide can be removed to levels below 1 ppm. This is particularly useful for removing iodide impurity from the concentrated feed brine used in typical industrial chloralkali electrolysis.

Specifically, the method involves an amount of solution in which the concentration of alkali metal chloride is greater than 100 g/l and the concentration of iodide is greater than 1 ppm. A separation bed is provided comprising a housing, a fluid inlet, a fluid outlet, and an ion retardation resin within the housing and the separation bed is characterized by a certain bed volume for fluid. The method further comprises adjusting the pH of the amount of aqueous alkali metal chloride solution to be less than about 10, and flowing the amount of aqueous alkali metal chloride solution through the separation bed in a series of loading and elution cycles. Such a loading and elution cycle comprises supplying a loading amount of the aqueous alkali metal chloride solution to the bed inlet, and flowing the loading amount through the ion retardation resin. As a result of these steps, iodide is preferentially adsorbed from the solution and alkali metal iodide depleted solution is obtained. The loading and elution cycle further comprises collecting the alkali metal iodide depleted solution from the bed outlet, supplying an elution amount of water to the bed inlet, and flowing the elution amount through the ion retardation resin. As a result of these further steps, adsorbed iodide is eluted and eluent comprising alkali metal iodide is obtained. Finally, the eluent is removed from the bed outlet, thereby resulting in the removal of alkali metal iodide from the amount of aqueous alkali metal chloride solution.

While the method can be employed in circumstances involving species comprising any alkali metal, the method is particularly suitable for use in circumstances in which the alkali metal iodide is sodium iodide and the aqueous alkali metal chloride solution is aqueous sodium chloride solution.

Further, as illustrated in the Examples below, the method is specifically suitable for use with solutions in which the concentration of iodide is greater than or about 10 ppm, and/or in which the concentration of sodium chloride is greater than or about 300 g/l. The method is also specifically suitable for use with solutions comprising sodium chlorate at a concentration greater than or about 20 g/l and/or comprising sodium sulphate at a concentration greater than or about 10 g/l. Further still, ion retardation resins of the betaine type are specifically suitable for use in these methods.

In certain embodiments of the method, the pH of the amount of aqueous sodium chloride solution can be adjusted to be less than about 7. In other embodiments, it is acceptable for the pH to be adjusted to be greater than about 4.

In the methods, an exemplary loading amount of the aqueous sodium chloride solution is an amount more than or about 10 bed volumes. Further, an exemplary elution amount of water is an amount less than or about 10 bed volumes.

The aforementioned methods are effective in removing sufficient sodium iodide such that the concentration of sodium iodide concentration in the collected sodium iodide depleted solution is less than or about 1 ppm.

In the elution, demineralized water can be used as the elution amount of water. Advantageously however, an additional elution amount of sodium hydroxide solution can be supplied to the bed inlet prior to supplying the elution amount of water to the bed inlet. This additional elution amount of the sodium hydroxide solution can be less than or about 1 bed volume in a concentration of less than or about 1 N. Further, the loading and elution cycles can be performed at ambient temperature.

Water from the eluent can optionally be recovered and used in subsequent cycles in the method. For instance, the eluent may be subjected to membrane filtration (e.g. reverse osmosis or nanofiltration) or ion exchange treatment thereby producing water and eluent comprising a greater concentration of alkali metal iodide. The water produced here can then gainfully be used as a source of water in the step of supplying an elution amount of water to the bed inlet.

The method is particularly suitable for use in membrane chloralkali electrolysis which involves purifying feed brine comprising aqueous alkali metal chloride solution, and then electrolyzing the purified feed brine in a membrane electrolyzer. The method can be used in the purifying step to remove alkali metal iodide from the aqueous alkali metal chloride solution. The method is useful in the electrolysis of any alkali metal chloride but finds significant application in the industrial electrolysis of sodium chloride.

A relevant membrane chloralkali electrolysis system thus comprises a membrane electrolyzer and a subsystem for purifying feed brine solution for the membrane electrolyzer. The subsystem comprises a separation bed comprising an ion retardation resin and subsystem is configured to remove alkali metal iodide from the aqueous alkali metal chloride solution according to the inventive method.

### BRIEF DESCRIPTION OF THE DRAWINGS

FIGS. 1a and 1b schematically show the loading cycle and the elution cycle respectively for the inventive method for iodide removal using ion retardation.

FIG. 2 shows a simplified schematic for an industrial chloralkali plant comprising a subsystem for removing sodium iodide from feed brine solution according to the method of the invention.

FIG. 3 plots inlet and outlet [NaCl] and [I⁻] against loading and elution volumes for the Example below using pH 10 feed brine and water for elution.

FIG. 4 plots inlet and outlet [NaCl] and [I⁻] against loading and elution volumes for the Example below using pH 6 feed brine and a small amount of NaOH followed by water for elution.

FIG. 5 plots inlet and outlet [NaCl] and [I⁻] against loading and elution volumes for the Example below using pH 4 feed brine and a small amount of NaOH followed by water for elution.

FIG. 6 plots inlet and outlet [NaCl] and [I⁻] against loading and elution volumes for the Example below using pH 6 feed brine and a larger amount of NaOH followed by water for elution.

FIG. 7 plots inlet and outlet [NaCl], [I⁻] and [SO₄⁻] against loading and elution volumes for the Example below using pH 6 feed brine also containing Na₂SO₄.

FIG. 8 plots inlet and outlet [NaCl], [I⁻] and [ClO₃⁻] against loading and elution volumes for the Example below using pH 6 feed brine also containing Na₂ClO₃.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

Herein, in a numerical context, the term “about” is to be construed as meaning plus or minus 10%. The term chloralkali refers to the two species chlorine and an alkali metal, e.g. such as the species produced by the electrolysis of a brine comprising an alkali metal chlorid sodium but also lithium, potassium, rubidium, cesium and francium.

Ion retardation resins are resins which contain both anionic and cationic adsorption sites which are so closely associated that they partially neutralize other's electrical charges. Such resins are described in detail in for instance U.S. Pat. No. 3,078,140. Ion retardation resins are also known as amphoteric resins.

The present invention generally relates to methods for removing alkali metal iodide from concentrated aqueous alkali metal chloride solutions using ion retardation resins. It has been found that ion retardation resins can be successfully used for removing iodide from concentrated solutions of alkali metal chloride. Specifically, these solutions comprise substantially more than 1 ppm iodide and have a concentration of alkali metal chloride which is greater than 100 g/l. Using these methods, iodide can be removed to levels below 1 ppm.

While the invention may be contemplated for use in the removal of any alkali metal iodide from any alkali metal chloride solution, it is particularly suitable for use in the removal of the sodium iodide which may be undesirably present in the concentrated feed brine employed as the supply in industrial chloralkali electrolysis plants.

In such applications, the concentration of sodium chloride in typical feed brines can be about 300 g/l or just below the saturation concentration. The concentration of iodide found in such feed brines can often be 10 ppm or more. And further, other species such as sodium chlorate (e.g. 20 g/l or more), sodium sulphate (10 g/l or more), and the like may also be present. Thus, the typical feed brine here is a complex, concentrated solution.

A suitable ion retardation resin for separating sodium iodide from such concentrated sodium chloride solutions is a betaine type of resin. Other resin types may also show efficacy and may be preferred for other related separations.

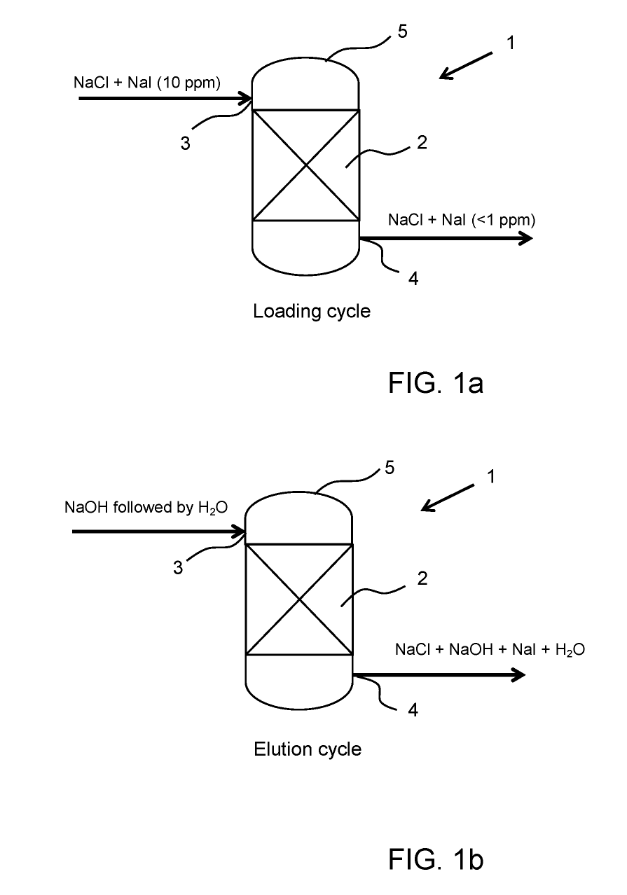

The separation process itself is relatively straightforward and first involves providing a separation bed containing the appropriate selected ion retardation resin. To achieve effective separation, the pH of the aqueous alkali metal chloride solution to be treated is adjusted as required so as to be less than about 10. Then the solution is flowed through the separation bed in a series of loading and elution cycles. This is illustrated schematically in FIGS. 1a and 1b for the exemplary separation of sodium iodide from sodium chloride solution.

In FIGS. 1a and 1b, separation bed 1 comprises ion retardation resin 2 which is contained in housing 5. Housing 5 has fluid inlet 3 and fluid outlet 4 located above and below resin 2 respectively. FIGS. 1a and 1b illustrate the loading and elution cycles respectively for this exemplary separation.

In the loading cycle of FIG. 1a, a loading amount of solution comprising NaCl and >10 ppm NaI is directed to inlet 3 and flowed through ion retardation resin 2. Iodide is preferentially adsorbed from the solution, and alkali metal depleted solution comprising NaCl and <1 ppm NaI is obtained from outlet 4 and is collected. Typically, the largest loading amount is selected that can be treated without saturating the resin with adsorbed iodide.

Then, in the elution cycle of FIG. 1b, an elution amount of water is directed to inlet 3 and flowed through ion retardation resin 2. The adsorbed iodide is eluted from the resin and eluent comprising NaCl, NaI, and water is obtained from outlet 4 and is removed. As demonstrated in the Examples below, the elution of iodide can be markedly improved by first flowing a small elution amount of NaOH solution through the resin prior to flowing the elution water therethrough. FIG. 1b thus shows an optional initial elution amount of NaOH being directed to inlet 3 which is then followed by water. Typically, the smallest elution amount of water is used that effectively removes the adsorbed iodide in preparation for another loading cycle. The loading and elution cycles are then repeated until all the desired solution has been treated.

Advantageously, the separations of the invention can be accomplished at ambient temperature. However, other temperatures may be considered and even preferred depending on the specific circumstances associated with the intended separation. It is expected that those of ordinary skill will be able to select appropriate resin types, pH, temperature, and other operating conditions for a given intended separation based on the general disclosure herein and the guidance provided from the examples that follow.

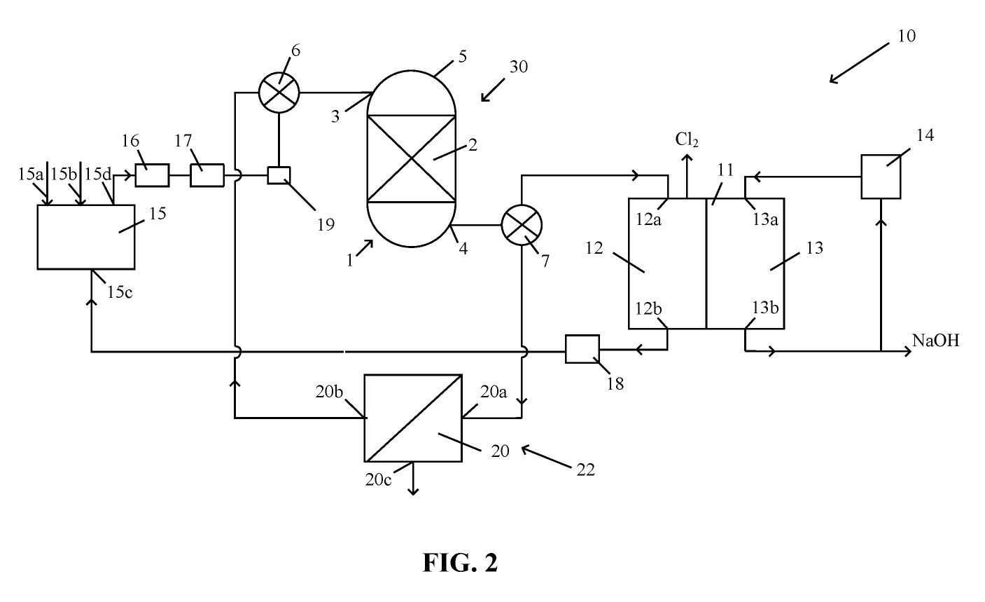

FIG. 2 depicts a simplified schematic of an exemplary embodiment for an industrial chloralkali plant which employs the inventive method to remove sodium iodide from feed brine solution. Here, industrial chloralkali plant 10 comprises subsystem 30 for purifying feed brine solution of iodide for membrane electrolyzer 11.

In the chlor-alkali plant 10 depicted in FIG. 2, purified NaCl based brine undergoes electrolysis in electrolyzer 11 to produce primary products chlorine gas at anode 12 and NaOH and hydrogen gas at cathode 13. Other products can then be obtained as a result of an additional series of reactions between these primary products. For instance, sodium chlorate product, NaClO₃, can be obtained by allowing the chlorine and NaOH caustic to intermix under appropriate controlled conditions (not shown). In plant 10, catholyte is provided to cathode inlet 13a of electrolyzer 11 from catholyte tank 14. Spent catholyte is withdrawn from cathode outlet 13b and one portion is recycled back to catholyte tank 14 while another portion is removed to obtain a supply of product (e.g. NaOH caustic product). Anolyte brine is prepared in saturator 15 and then provided from saturator outlet 15d to anode inlet 12a of electrolyzer 11. Spent anolyte is withdrawn from anode outlet 12b and is recycled back to saturator 15 at recycle inlet 15c for reuse. The appropriate concentration of NaCl brine for the electrolysis process is maintained by adding the right amounts of process solid crystalline salt and process water at saturator inlets 15a and 15b respectively.

Chlor-alkali plant 10 also includes other subsystems for purification and control purposes. For instance, chlor-alkali plant 10 comprises primary treatment subsystem 16 and secondary treatment subsystem 17 which are used to remove impurities from the anolyte brine prepared in saturator 15. In primary treatment subsystem 16, caustic and soda ash are typically added to precipitate out Ca and Mg impurities. In secondary treatment subsystem 17, other trace metal impurities are removed by ion exchange techniques. Also shown in FIG. 2 is dechlorination subsystem 18 for removing chlorine from the brine stream following electrolysis. (Note that other components and/or subsystems, such as a storage tank for purified feed brine (e.g. between three way valve 7 and anode inlet 12a), pumps, heat exchangers, control subsystems, are typically employed in an industrial chlor-alkali plant like that shown in FIG. 2, but these have been omitted for simplicity.)

In order to remove iodide, subsystem 30 includes separation bed 1 which functions similarly to that shown in FIGS. 1a and 1b (thus, like numerals have been used to denote elements that are common to each of these figures). The iodide in the treated anolyte brine from secondary treatment subsystem 17 is removed in a series of loading cycles by setting three way valve 6 so as to allow brine to flow from the outlet of secondary treatment subsystem 17 to bed inlet 3 and through ion retardation resin 2. Iodide depleted solution (purified feed brine) is directed from bed outlet 4 to anode inlet 12a of electrolyzer 11 by appropriate setting of three way valve 7.

Elution cycles are performed as required by appropriately setting three way valves 6 and 7 such that elution fluid is appropriately directed to bed inlet 3 and eluent is appropriately removed from bed outlet 4. Here, membrane filtration apparatus 20 (e.g. reverse osmosis unit, nanofiltration unit) has optionally been included in subsystem 30 for purposes of recovering water from the eluent and to reuse that recovered water in the ion retardation separation process. Thus as shown, during elution cycles, water from membrane filtration permeate outlet 20b is directed to bed inlet 3 and eluent from bed outlet 4 is directed to membrane filtration feed inlet 20a. The concentrated eluent (i.e. greater [NAI]) is removed at membrane filtration pass outlet 20c. Such an arrangement provides for efficient use of resource water and reduces waste with little additional energy required.

As shown in FIG. 2, chloralkali plant 10 also comprises subsystem 19 which is located between secondary treatment subsystem 17 and bed inlet 3 and is provided for adjusting pH of the brine stream (e.g. via addition of NaOH) to values below 10 prior to entering separation bed 1 and/or for providing a source of NaOH to prepare the optional additional initial elution amount of dilute NaOH which may desirably be supplied to the bed during elution cycles.

FIG. 2 illustrates an exemplary embodiment of a chloralkali plant incorporating a subsystem for removing iodide according to the invention. However, it will be apparent to those skilled in the art that various other arrangements are possible, including other arrangements for recovering water from the eluent produced.

The method of the invention relies on the unexpected preferential adsorption affinity of low level iodide ions (ppm) over chloride ions in saturated alkali metal chloride solution matrices. As is well known by those familiar with conventional ion retardation chemistry, it is generally not possible to predict for instance that a low (ppm) level of iodide would have sufficient adsorption affinity over a high concentration of chloride ions in saturated alkali metal chloride solutions such that iodide could be preferentially adsorbed and separated to produce purified brine with <1 ppm iodide.

The present method is comparatively much less complex and expensive to perform commercially than prior art ion-exchange processes and only involves two-step loading and elution cycles. It is expected to significantly improve the overall economics of brine purification operations by significantly reducing operational expenditure as well as by minimizing the amount of waste brine purge required for disposal. Further, a broader range of brine or salt sources with higher levels of iodide impurities but with lower raw material costs may now be considered. A potential disadvantage of the process relates to the amount of (demineralized) water potentially required for the elution cycle and a requirement to process the waste eluent stream produced before disposal. However, as disclosed above, both issues can be addressed by subjecting the eluent to membrane filtration, thereby reducing the requirement for water as a result of an energy efficient processing of the waste eluent stream.

The following examples are illustrative of aspects of the invention but should not be construed as limiting in any way.

### Examples

A series of experiments was performed to investigate the removal of iodide using an ion retardation separation process from sodium chloride brine solutions typically found in industrial chloralkali electrolysis. In all cases, the solutions had a sodium chloride concentration of 300 g/l and an iodide concentration of 10 mg/l. However, the pH of the solutions and the presence of other species varied in the experiments as indicated below.

In each experiment, fresh Mitsubishi AMP03 amphoteric resin (a betaine type of ion retardation resin) was used in a separation bed of known bed volume. A single cycle of loading followed by elution was used. Initially, the indicated loading amount of solution (in units of bed volumes) was flowed through the resin. Then, the indicated elution amount was flowed through the resin. Both loading and elution were performed at ambient temperature.

In all cases, demineralized water was primarily used for elution. However, where indicated, a small amount of NaOH solution was flowed through the resin initially during the elution cycle, after which demineralized water was used for the remainder of the elution.

The concentrations of NaCl, I⁻, and other species were measured periodically at both the bed inlet and outlet during loading and elution. In the plots that follow, the X axis first represents the loading amount flowed through the resin (in bed volumes) which is then followed by the elution amount flowed through the resin (again in bed volumes). A solid vertical line in each plot indicates the transition from the loading cycle to the elution cycle. In all cases, about 10 or slightly more bed volumes of brine solution was flowed through as the loading amount which was then followed by NaOH solution (where applicable) and at last demineralized water as the elution amount. The Y axis in each plot refers to the multiple species measured in each experiment. Iodide is plotted in terms of ppm as iodide, and NaCl is plotted in terms of %. Where applicable, sulphate and chlorate are plotted in terms of g/L.

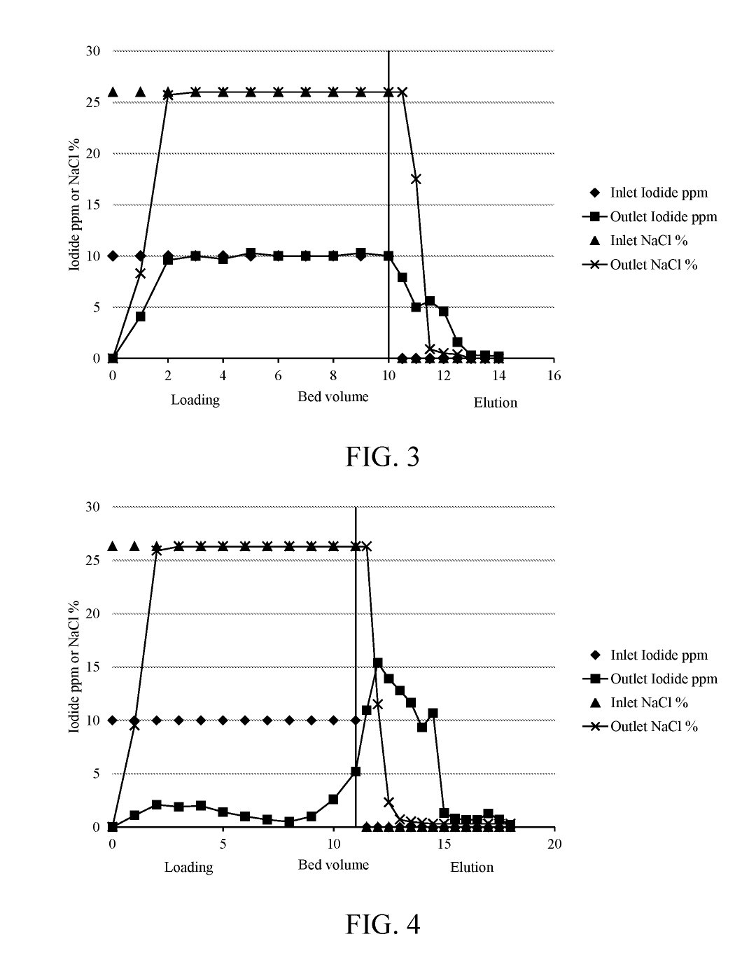

In a first experiment, the sodium chloride brine had a pH of 10 and water alone was used for elution. FIG. 3 plots inlet and outlet [NaCl] and [I⁻] against loading volume followed then by elution volume. These results show almost no uptake or absorption of iodide during the loading step for feed brine at this pH.

FIG. 4 however shows results of a similar experiment except that this time the brine pH was 6. Also this time, 0.5 bed volume worth of 0.1 N NaOH solution was initially used during elution. Again, inlet and outlet [NaCl] and [I⁻] are plotted against loading followed by elution volumes. This time, a substantial amount of iodide was adsorbed by the resin during the loading step, and thus demonstrates the importance of pH on the absorption process. Further, the use of the initial amount of 0.1 N NaOH solution for elution seemed to enhance the desorption of iodide during the elution step. The iodide concentration at the bed outlet rose to a maximum of 15 mg/l during elution.

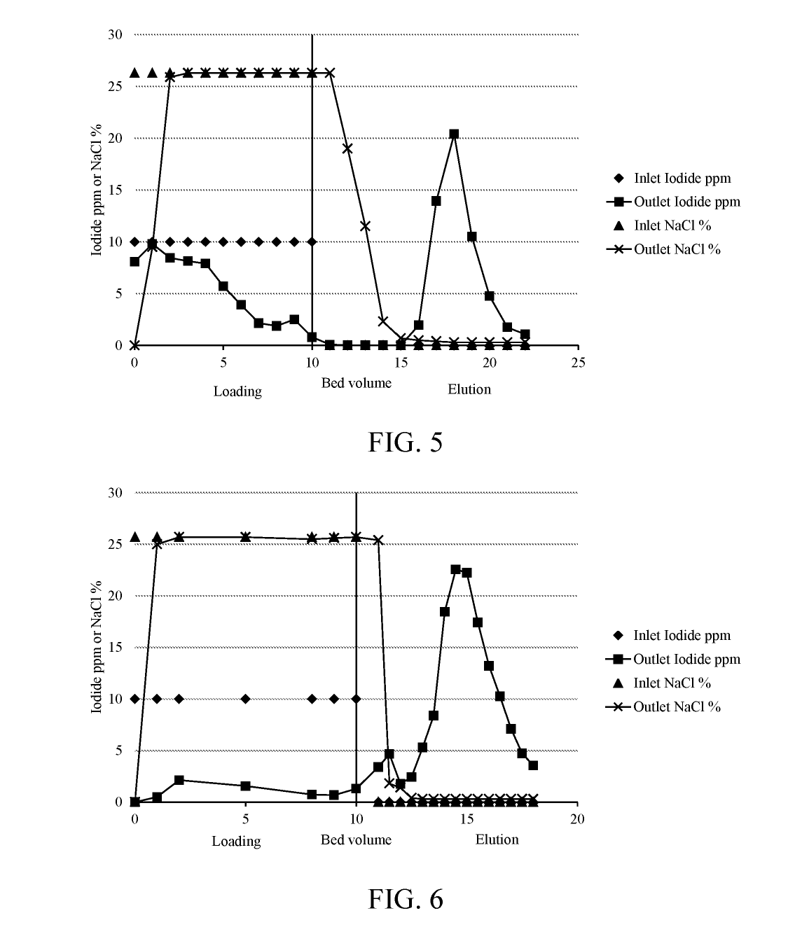

FIG. 5 shows results of a similar experiment where the pH of the brine was even lower, namely a pH of 4. Again, 0.5 bed volume worth of 0.1 N NaOH solution was initially used during elution. And again, inlet and outlet [NaCl] and [I⁻] are plotted against loading followed by elution volumes. As is apparent from FIG. 5, the uptake or absorption of iodide was not significantly improved at this lower pH.

In yet another variation, a similar experiment to that shown in FIG. 4 was performed except using a larger volume of NaOH solution during elution, namely 1 bed volume worth of 0.1 N NaOH solution. Again here, FIG. 6 plots inlet and outlet [NaCl] and [I⁻] against loading followed by elution volumes. The results here show no significant improvement in elution using the greater initial volume of NaOH in the elution step.

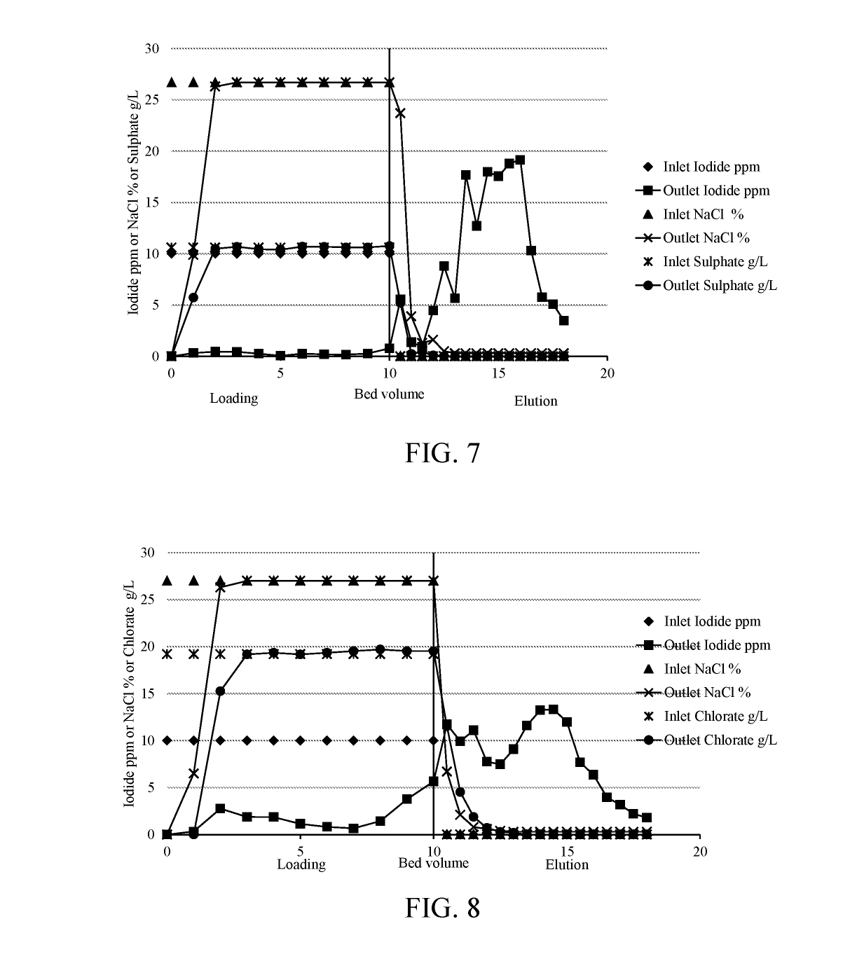

The next two experiments illustrate that the results are generally unaffected by the presence of significant amounts of sodium sulphate and/or sodium chlorate in the feed brine solution. The results shown in FIG. 7 were obtained using sodium chloride brine solution as in the second example above (i.e. pH of 6) but additionally comprising 10 g/l Na₂SO₄. Again here an initial 0.5 bed volume of NaOH solution was used for elution. FIG. 7 plots inlet and outlet [NaCl], [I⁻] and [SO₄⁻] against loading followed by elution volumes. As is evident from this figure, the results obtained previously for iodide loading and elution were not significantly affected by the presence of sodium sulphate.

In a like manner to the preceding, the results shown in FIG. 8 were obtained using sodium chloride brine solution with a pH of 6 but additionally comprising 20 g/l NaClO₃. And again, an initial 0.5 bed volume of NaOH solution was used for elution. FIG. 8 plots inlet and outlet [NaCl], [I⁻] and [ClO₃⁻] against loading followed by elution volumes. And again, as is evident from FIG. 8, the results obtained previously for iodide loading and elution were not significantly affected by the presence of sodium chlorate.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method for removing an alkali metal iodide from an amount of aqueous alkali metal chloride solution, the concentration of alkali metal chloride in the solution being greater than 100 g/l and the concentration of iodide in the solution being greater than 1 ppm, the method comprising:
providing a separation bed comprising a housing, a fluid inlet, a fluid outlet, and an ion retardation resin within the housing wherein the separation bed has a bed volume for fluid;
adjusting the pH of the amount of aqueous alkali metal chloride solution to be less than about 10; and
flowing the amount of aqueous alkali metal chloride solution through the separation bed in a series of loading and elution cycles, wherein a loading and elution cycle comprises:
supplying a loading amount of the aqueous alkali metal chloride solution to the bed inlet;
flowing the loading amount through the ion retardation resin whereby iodide is preferentially adsorbed from the solution and alkali metal iodide depleted solution is obtained;
collecting the alkali metal iodide depleted solution from the bed outlet;
supplying an elution amount of water to the bed inlet;
flowing the elution amount through the ion retardation resin whereby adsorbed iodide is eluted and eluent comprising alkali metal iodide is obtained; and
removing the eluent from the bed outlet; and
thereby removing alkali metal iodide from the amount of aqueous alkali metal chloride solution.

2. The method of claim 1 wherein the alkali metal iodide is sodium iodide and the aqueous alkali metal chloride solution is aqueous sodium chloride solution.

3. The method of claim 2 wherein the concentration of iodide in the solution is greater than or about 10 ppm.

4. The method of claim 2 wherein the concentration of sodium chloride in the solution is greater than or about 300 g/l.

5. The method of claim 2 wherein the amount of aqueous sodium chloride solution comprises sodium chlorate at a concentration greater than or about 20 g/l.

6. The method of claim 2 wherein the amount of aqueous sodium chloride solution comprises sodium sulphate at a concentration greater than or about 10 g/l.

7. The method of claim 2 wherein the ion retardation resin is a betaine type of ion retardation resin.

8. The method of claim 2 comprising adjusting the pH of the amount of aqueous sodium chloride solution to be less than about 7.

9. The method of claim 8 comprising adjusting the pH of the amount of aqueous sodium chloride solution to be greater than about 4.

10. The method of claim 2 wherein the loading amount of the aqueous sodium chloride solution is more than or about 10 bed volumes.

11. The method of claim 2 wherein the elution amount of water is less than or about 10 bed volumes.

12. The method of claim 2 wherein the concentration of sodium iodide concentration in the collected sodium iodide depleted solution is less than or about 1 ppm.

13. The method of claim 1 wherein the elution amount of water is demineralized water.

14. The method of claim 2 comprising supplying an additional elution amount of sodium hydroxide solution to the bed inlet prior to supplying the elution amount of water to the bed inlet.

15. The method of claim 14 wherein the additional elution amount of the sodium hydroxide solution is less than or about 1 bed volume.

16. The method of claim 14 wherein the concentration of the sodium hydroxide solution is less than or about 1 N.

17. The method of claim 1 wherein the loading and elution cycles are performed at ambient temperature.

18. The method of claim 1 comprising:
subjecting the eluent to membrane filtration thereby producing water and eluent comprising a greater concentration of alkali metal iodide; and
using the produced water in the step of supplying an elution amount of water to the bed inlet.

19. A method of membrane chloralkali electrolysis comprising:
purifying feed brine comprising aqueous alkali metal chloride solution; and
electrolyzing the purified feed brine in a membrane electrolyzer;
wherein the purifying step comprises removing alkali metal iodide from the aqueous alkali metal chloride solution according to the method of claim 1.

20. A membrane chloralkali electrolysis system comprising a membrane electrolyzer and a subsystem for purifying feed brine solution for the membrane electrolyzer, wherein the subsystem comprises a separation bed comprising an ion retardation resin and the subsystem is configured to remove alkali metal iodide from the aqueous alkali metal chloride solution according to the method of claim 19.
